(19) United States
(12) Patent Application Publication
(10) Pub. No.: US 2020/0316492 A1
(43) Pub. Date: Oct. 8, 2020

(54) Extraction System with Dual-Purpose Pump

(71) Applicant: Frederick Jackson Chess, Seattle, WA (US)

(72) Inventor: Frederick Jackson Chess, Seattle, WA (US)

(21) Appl. No.: 16/373,842

(22) Filed: Apr. 3, 2019

(51) Int. Cl. B01D 11/02; C11B 1/10; B01D 11/04; F04B 15/08

(52) U.S. Cl. CPC B01D 11/0203; C11B 1/104; B01D 11/0296; B01D 2011/007; B01D 11/0492; F04B 15/08; B01D 11/0407

(57) ABSTRACT

Provided is an extraction system which can be used to recover light oils and other organic materials during a supercritical or subcritical fluid extraction. The extraction system utilizes dual-purpose gas-liquid extraction pump for pumping the extracting material (e.g., CO₂) in either the vapor phase or the liquid phase within the extractor. The extractor is a pressure vessel which functions as an independent, full spectrum extractor. Organic material is inserted within a compartment within the extractor and liquefied and compressed gases are passed through the organic material to obtain the extractant. The extraction system also includes a separator to separate the extracting fluid from the extracted material.

### I. BACKGROUND

A. Technical Field

Provided is an extraction system for subcritical and supercritical extractions which utilizes a multifunctional dual-purpose gas-liquid extraction pump capable of pumping vapor or liquid within the extraction system. The dual-purpose gas-liquid extraction pump is capable of building relatively high amounts of pressure and pulling a deep vacuum within the extraction system.

B. Description of Related Art

Supercritical CO₂ extraction was originally developed by Germany in the 1930's to extract crude oil from shale for the war effort of World War II. After the conflict ended, it was shown that the same process could be used for extracting flavoring oils from hops for the German beer industry. To this day, the largest CO₂ extractors are used for making hops oils for beer.

CO₂ extraction generally operates in the following manner. First, plant or other organic or raw materials are inserted into a vessel which operates as an extractor. Next, CO₂ gas is pumped from a CO₂ tank through a conduit to the extractor. The extractor is pressurized and maintained at a certain temperature so that CO₂ gas is compressed to a liquid or supercritical fluid upon its entry into the extractor. In certain cases, the exterior of the extractor may be insulated with an insulation jacket to assist in maintaining the temperature within the extractor. As the liquefied CO₂ passes through the plant or other organic or raw material within the extractor, it acts as a solvent, removing (i.e., extracting) various oils and compounds from the plant or other raw materials. The liquefied CO₂ containing the extracted oils and compounds is then transferred or pumped to a separator. The separator is maintained at a different temperature and pressure than the extractor which results in the separation of the oil and other extracted compounds from the liquefied CO₂ and the conversion of liquefied CO₂ into CO₂ gas. For example, in certain cases, the extractor is maintained at a pressure of about 1000 psi and the separator is maintained at a pressure of about 200 to about 400 psi to enable the extraction process to be carried out. After entering the separator, oil and other extracted compounds separate from the liquefied CO₂ and fall into a collection vessel at the bottom of the separator while the CO₂ gas is transferred or pumped through a conduit to either a CO₂ tank or to the extractor to be recirculated through the system.

Early CO₂ extractors were linear, meaning that they only flowed in one direction. In these types of extractors, liquid CO₂ is pumped through the extraction vessel at high pressure to extract the oils that are in the solid material in the vessel. The oil saturated liquid CO₂ passes through a pressure regulating valve and then de-pressurizes into a separator vessel where the oil ends up. The de-pressurization causes the liquid phase of the CO₂ to flash to vapor which leads to the oil falling out into the separator vessel. This is because gas vapor is not capable of holding oils. The CO₂ vapor at the end of the cycle would then be simply vented off and disposed of.

Later CO₂ extractor designs sought greater efficiency by recovering and recycling the CO₂. The simplest way to do this is through use of a vapor pump or gas booster. In this type of extractor design, vapor enters into the inlet of the pump and is pumped to a pressure where it is either a liquid or a supercritical fluid. A simple description of a supercritical fluid is that it looks like a very dense fog. This solution is directed or pumped through the extractor vessel to separate oils. It then flows to the separator where the oil falls out of the vapor. This vapor exits the top of the separator and goes directly to the inlet of the pump where it immediately is re-pressurized and recirculated through the extractor vessel. This is a very simple design that is relatively inexpensive to build. However, it has several drawbacks. First, pumping vapor is inefficient. A cubic foot of CO₂ vapor weighs 5 pounds, whereas a cubic foot of liquid weighs 45 pounds. Second, gas booster pumps are designed to pump pure gasses. In a CO₂ extractor, the vapor always has some light volatile oils entrained in it. These oils carbonize and turn to grit as they pass through the pump causing damage and leading to constant maintenance issues.

Liquid extraction systems, in contrast are much faster and require less maintenance. As such, liquid extraction systems are superior in certain respects over vapor extraction systems. In this type of design, vapor leaving the separator goes through a cooling and condensing system where it is turned back into liquid before it enters the inlet of the pump. However, liquid extraction systems are complex and more expensive to build and exhibit terpene retention and vapor recovery issues.

There are also extraction system designs which use a liquid pump for extraction and a vapor pump for recovery. However, these designs are deeply flawed and are not worthy of consideration.

Despite improvements to the CO₂ extraction process, various obstacles exist which limit the use of CO₂ extraction due to the high price of manufacturing various equipment associated with the extraction system including the vessels, valves, pumps, etc. required to carry out the extraction process. The source of the expense for the extraction equipment lies in the fact that such equipment must be manufactured in accordance with rigorous standards to meet the operational conditions of the extraction process such as extreme operational pressures (e.g., up to about 15,000 psi). Other sources of high operational costs are associated with the energy used to perform an extraction. The first energy intensive part of the process involves a high-pressure pump which must first compress the CO₂ to anywhere from 800 to 15,000 psi through the extractor vessel. The resulting stream of extract saturated CO₂ then de-pressurizes into a separator vessel in which the CO₂ flashes to vapor, thereby causing the extract to drop out into the bottom of the vessel. The vaporized CO₂ must then be cooled so it returns to a liquid state before it returns to the pump inlet. These steps of pumping, compressing, depressurizing and cooling are all very energy intensive.

Pressurizing the CO₂, heating it as it cools, then cooling it when it is hot requires a large amount of electricity. One solution to this problem is to use CO₂ extraction systems which eliminate several of the pressure vessels involved in separation of extracts from CO₂ and condensing CO₂ and to eliminate associated heaters and chillers in such extraction systems. Such embodiments result in the reduction of pumping costs due to the circulating CO₂ remaining at one steady pressure at the inlet and outlet of the pump which allows the pump to work less hard. These types of CO₂ extraction systems are disclosed in U.S. Pat. No. 10,092,855 which is hereby incorporated by reference in its entirety.

The subject matter of the present inventive disclosure provides an alternative for streamlining the extraction process and for reducing costs by taking advantage of the favorable parts of the liquid and vapor pump configurations and working around the downsides of both. Specifically, the present disclosure relates to a process and apparatus for transitioning between pumping CO₂ in the vapor phase and pumping CO₂ in the liquid phase within the extractor. Accordingly, the extraction process disclosed herein includes a first step wherein CO₂ is pumped in vapor phase within the extractor at the beginning of a supercritical CO₂ extraction. Extraction through the vapor phase is often a superior method for extracting and collecting monoterpenes because it is a slower extraction process and the recollection of CO₂ can be performed at lower pressures. These two traits are important because terpenes extract very quickly. A rapid extraction risks pulling heavier resins and mixing them with the terpenes. These light oils have very low boiling points meaning that they evaporate easily. When CO₂ de-pressurizes from liquid to vapor at low pressures, it freezes, allowing the terpenes to be entrained in dry ice so that they can't evaporate.

Once the terpenes have been separated from the plant material, the extractor is switched to liquid phase. This may be described as the second step of the process where liquid CO₂ is pumped in liquid phase within the extractor. This results in a much faster and more thorough extraction of heavier oils and resins. At the end of the extraction cycle, a typical liquid pump can only recover and recycle the liquid phase of the CO₂. CO₂ vapor must be vented off and discarded. The new design disclosed herein allows for the complete recovery of vapor CO₂ since the pump is capable of seamlessly switching between pumping liquid and pumping vapor and is also capable of creating a deep vacuum which can remove nearly all of the gas molecules from the extraction.

### II. SUMMARY

Provided is an extraction system. The extraction system includes the following components: a tank containing gas which includes an inlet for filling the tank with gas and an outlet for allowing the gas to be transferred within the extraction system; a dual-purpose gas-liquid extraction pump in connection with the tank wherein the pump is capable of pumping either gas or vapor phase extracting material or liquid phase extracting material throughout the extraction system in a gas phase or a liquid phase extraction process; an extractor pressure vessel in connection with the multifunctional dual-purpose gas-liquid extraction pump, wherein the extractor pressure vessel includes an entry port, an entry tube, a main body and a collection zone, wherein the main body comprises an extraction chamber, wherein the extraction chamber houses material to be extracted; and a separator pressure vessel in connection with the extractor pressure vessel, wherein the separator pressure vessel includes an entry port, an entry tube, a separation zone, a collection zone, an exit tube and an exit port, wherein the exit port is connected to the gas-liquid extraction pump and an external condenser by at least one conduit, wherein flow of material from the exit port to either the gas-liquid extraction pump or the external condenser is controlled by a valve.

According to further aspects of the extraction system, the extraction system includes an accumulator in connection with the external condenser, wherein the accumulator stores liquid extracting material, wherein the accumulator is in connection with the gas-liquid extraction pump

According to further aspects of the extraction system, the gas-liquid extraction pump includes a switch allowing the gas-liquid extraction pump to alternate between gas mode for pumping CO₂ gas or vapor within the extraction system and liquid mode for pumping liquid CO₂ or supercritical CO₂ within the extraction system.

According to further aspects of the extraction system, the gas-liquid extraction pump pressurizes the gas or vapor phase extracting material and pumps the gas or vapor phase extracting material within an extraction pressure vessel when the extraction system is operating in the gas or vapor phase.

According to further aspects of the extraction system, the gas-liquid extraction pump creates a vacuum which pulls the liquid phase extracting material stored in the accumulator and pumps liquid phase extracting material within the extraction pressure vessel when the extraction system is operating in the liquid phase.

According to further aspects of the extraction system, the gas-liquid extraction pump recirculates the extracting material in the gas or vapor phase by creating a vacuum to pull and receive extracting material exiting the exit tube and exit port of the separator, wherein the valve directs flow of the extracting material to the gas-liquid extraction pump.

According to further aspects of the extraction system, the valve between the gas-liquid extraction pump and the condenser directs the flow of the extracting material exiting the exit tube and exit port of the separator to the condenser which converts extracting material in the gas or vapor phase to the liquid phase, wherein the liquid phase extracting material is transported to the accumulator for storage and wherein the gas-liquid extraction pump creates a vacuum to pull and receive liquid phase extracting material from the accumulator for circulation within the extraction system.

According to further aspects of the extraction system, the extraction system includes a valve between the condenser and the accumulator which allows for flow of the liquid phase extracting material to bypass the accumulator and for flow of the liquid phase extracting material to be directed to the gas-liquid extraction pump for recirculation within the extraction system when storage of the liquid phase extracting material within the accumulator is not necessary.

According to further aspects of the extraction system, the gas-liquid extraction pump is explosion proof which enables it to work with different types of flammable compressed gasses.

According to further aspects of the extraction system, the extracting material is CO₂ gas, liquid CO₂ and supercritical CO₂.

According to further aspects of the extraction system, the gas-liquid extraction pump is capable of pumping flammable gases separately or in conjunction with CO₂.

According to further aspects of the extraction system, the extraction system, when operated in the gas or vapor phase extracts essential oils and wherein the extraction system, when operated in the liquid phase, extracts oleo resins and heavy oils.

Also provided is a method of extracting compounds from an organic material. The method includes the following steps: providing an extraction system as described above; conducting a first phase extraction, wherein the first phase extraction includes the following steps: i.) using the gas-liquid extraction pump to pump CO₂ gas or vapor extracting material into the extraction vessel to pass through organic material within the extraction vessel to entrain the organic material within the extracting material; ii) separating organic material from the CO₂ gas or vapor by passing the gas or vapor through at least one separator vessel; iii.) collecting extracted and separated materials from the separator vessel; iv.) recirculating the CO₂ gas or vapor extracting material through the extraction system by directing CO₂ gas or vapor from the separator vessel to the gas-liquid extraction pump to recirculate the CO₂ gas or vapor extracting material through the extraction vessel; conducting a second phase extraction, wherein the second phase extraction includes the following steps: i.) using the gas-liquid extraction pump to pump liquid or supercritical CO₂ extracting material into the extraction vessel to pass through organic material within the extraction vessel to entrain the organic material within the extracting material; ii.) separating organic material from the liquid or supercritical CO₂ by passing the liquid or supercritical CO₂ through at least one separator vessel which converts the liquid or supercritical CO₂ to a gas or vapor; iii.) collecting extracted and separated materials from the separator vessel; and iv.) recirculating the CO₂ extracting material through the extraction system by directing CO₂ gas or vapor from the separator vessel to the external condenser to convert the CO₂ gas or vapor to the liquid phase and optionally storing the liquid phase CO₂ within the accumulator; and v.) operating the gas-liquid extraction pump to create a vacuum to pull the liquid phase CO₂ from the condenser or the accumulator and recirculate liquid phase CO₂ through the extraction vessel.

According to further aspects of the present teaching, the method includes the step of operating a switch on the gas-liquid extraction pump to alternate operation of the extraction system between the gas or vapor phase (the first phase extraction) and the liquid phase (the second phase extraction).

According to further aspects of the present teaching, the method includes the step of operating the valve between the gas-liquid extraction pump and the condenser to direct flow of the extracting material in the gas or vapor phase exiting the exit tube and exit port of the separator to the either the gas-liquid extraction pump for continuous extraction in the gas or vapor phase (first phase extraction) or to the condenser for continuous extraction in the liquid phase (second phase extraction).

### III. BRIEF DESCRIPTION OF THE DRAWINGS

FIG. 1 illustrates an exemplary CO₂ extraction system.

FIG. 2 illustrates an exemplary extraction vessel and separator of a CO₂ extraction system.

FIG. 3 illustrates an exemplary extractor vessel of a CO₂ extraction system.

FIG. 4 illustrates an exemplary separator vessel of a CO₂ extraction system.

FIG. 5 illustrates an exemplary condensing system and accumulator of a CO₂ extraction system.

FIG. 6 illustrates a graph showing the flow rate capable of being generated by exemplary models of the gas-liquid extraction pump.

### IV. DETAILED DESCRIPTION

Provided is an extraction system and associated methods. The extraction system may incorporate the use of any type of extracting material or solvent for use within the system.

One aspect of the extraction system disclosed herein is that it utilizes a multifunctional dual-purpose gas-liquid extraction pump capable of pumping either gas or vapor or liquid throughout the extraction system. The multifunctional dual-purpose gas-liquid extraction pump is capable of building relatively high amounts of pressure and pulling a deep vacuum within the extraction system. In certain embodiments, the gas-liquid extraction pump is explosion proof which enables it to work with different types of flammable compressed gases. The dual-purpose gas-liquid extraction pump may also be explosion proof in that there is nothing within the pump itself that could potentially cause a spark. For example, in certain cases, the pumps are pneumatically driven by an air compressor in a remote location and do not possess any characteristics that could potentially ignite a spark. These pumps simply pull a vacuum, drawing air, gas or liquid into the pump. The pump may have an explosion proof electric motor which shields the motor from the outside environment.

Previous extraction system designs have been limited to only one of two phases—the gas or vapor phase and the liquid phase. Extraction systems which operate in the gas or vapor phase and extraction systems which operate in the liquid phase each have their advantages and disadvantages. The newly expanded design disclosed herein allows an operator to switch back and forth at appropriate intervals between extracting materials in the gas or vapor phase and extracting materials in the liquid phase by operating a switch in the gas-liquid extraction pump. This switch allows the gas-liquid extraction pump to alternate between a gas or vapor mode for pumping CO₂ gas or vapor within the extraction system and a liquid mode for pumping liquid CO₂ or supercritical CO₂ within the extraction system. When operating in the gas or vapor phase, the gas-liquid extraction pump pressurizes the gas or vapor phase extracting material and pumps the gas or vapor phase extracting material within an extraction pressure vessel. Alternatively, when operating in the liquid phase, the gas-liquid extraction pump creates a vacuum which pulls the liquid phase extracting material stored in an accumulator, pressurizes the liquid extracting material and pumps liquid phase extracting material within the extraction pressure vessel. The gas-liquid extraction pump allows the operator to take advantage of both gas and liquid phase extractions when they are best suited to the overall process. In certain embodiments, pressure is generated within the extraction system solely by the dual-purpose gas-liquid extraction pump. In further embodiments, the gas-liquid extraction pump is explosion proof and capable of pulling a vacuum. These features enable the pump to work with flammable gases separately or in conjunction with CO₂ and allows for greater versatility in extraction parameters.

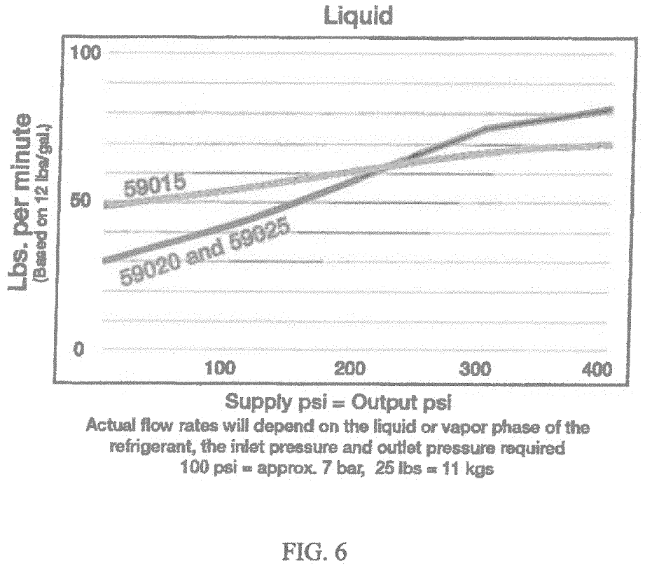

A non-limiting example of a gas-liquid extraction pump which may be utilized with the extraction system described herein is a Haskel pump (e.g., Models 59015, 59020 and 59025) provided by Accudyne Industries (Burbank, Ca). The dual-purpose gas-liquid extraction pump is capable of transferring the extracting material throughout the extraction system across a wide pressure range including pressures of up to 1,200 psi. The dual-purpose gas-liquid extraction pump may transfer extracting material throughout the extraction system without generating heat during liquid transfer, with only minor warming during gas or vapor transfer and without the extracting material being heated by the pump motor. The dual-purpose gas-liquid extraction pump may also include the capability of allowing the user to adjust completely variable operational speeds from zero to maximum lbs (kg)/minute, to start against load and to run dry with no need for unloaders or bypass valving. In certain embodiments, the dual-purpose gas-liquid extraction pump is an integral pump having a linear air motor assembly which is pneumatically driven and capable of operating from an air hose. In further embodiments, lubrication of the dual-purpose gas-liquid extraction pump is not required, in that nothing is required to be added to the extracting material whether in the form of a liquid, gas or vapor. FIG. 6 provides a graph of the flow rates for various models of the dual-purpose gas-liquid extraction pump.

The dual-purpose gas-liquid extraction pump may be used with various types of compressed gasses. Examples of compressed gases which may be used with the dual-purpose gas-liquid extraction pump disclosed herein include but are not limited to propane, butane, R134a, dimethyl ether and carbon dioxide. In certain embodiments, the compressed gas which may be utilized within the extraction system disclosed herein is CO₂. Accordingly, in certain embodiments, the extraction system utilizes CO₂ as the extracting material and the extraction system disclosed herein may be referred to as a CO₂ extraction system. The CO₂ extraction system may include various component parts, including but not limited to a CO₂ source (e.g., a CO₂ tank), one or more pumps, an extractor or pressure vessel, optionally a filtration system, at least one separator and a collection vessel or accumulator.

CO₂ extraction systems generally operate in the following manner. First, plant or other organic or raw materials are inserted into an extractor vessel (hereinafter referred to as the “extractor”). Next, CO₂ gas is pumped from the CO₂ tank through a conduit to the extractor. The extractor is pressurized and maintained at a certain temperature so that CO₂ gas is compressed to a liquid or supercritical fluid upon its entry into the extractor. In general, the pump pressurizes the CO₂ gas to a liquid or supercritical fluid as it enters the extractor. The extractor may be pressurized anywhere from about 800 to about 15,000 pounds per square inch (psi) and the temperature of the extractor may be set anywhere from 20° C. to about 50° C. In certain cases, the extractor is pressurized up to about 1000 psi or more (e.g., in certain cases the extractor may be pressurized to up to 1200 psi). In certain embodiments, the exterior of the extractor is insulated with an insulation jacket to assist in maintaining the temperature within the extractor so that the CO₂ remains in liquid or supercritical form as it passes through the extractor. The liquefied or supercritical CO₂ passes through the plant or other organic or raw material within the extractor and acts as a solvent, removing (i.e., extracting) various oils and compounds from the plant or other raw materials. The liquefied or supercritical CO₂ containing the extracted oils and compounds is then transferred or pumped to a separator. The separator is maintained at a different temperature and pressure than the extractor which results in the separation of the oil and other extracted compounds from the liquefied CO₂ and the conversion of liquefied or supercritical CO₂ into CO₂ gas. In certain embodiments involving a liquid phase extraction, the separator may be maintained at a pressure ranging from about 800 to about 900 psi. However, in other embodiments involving a gas phase extraction, the separator may be maintained at a pressure ranging from about 200 psi to about 400 psi and in some cases between about 350 psi to about 400 psi. In general, the separator may be maintained at a higher temperature than the extractor to separate the extractant from the extracting material. For example, the temperature of the separator may be set from about 50° C. to about 60° C. or at any other temperature which allows for the liquid or supercritical CO₂ or other extracting material to be converted to a gas. This allows oil and other extracted compounds to fall into a collection vessel at the bottom of the separator while the CO₂ gas to rise within the separator and be transferred or pumped through a conduit to either the CO₂ tank or to the extractor to be recirculated through the system.

Accordingly, the separation and collection steps of the CO₂ extraction system occur within one or more pressurized vessel(s) referred to as separator vessels or a separator. The separator is considered a low-pressure vessel relative to the extraction vessel. In one embodiment, plant or other raw materials are inserted into the extraction vessel, CO₂ gas is pumped from the CO₂ tank through a conduit into the extraction vessel, which is pressurized and maintained at a certain temperature to compress the CO₂ gas into a liquid or supercritical fluid. As mentioned above, the pump pressurizes the CO₂ as it enters the extractor. The liquefied or supercritical CO₂ then passes through the plant or other raw material within the extraction vessel and acts as a solvent, removing (i.e., extracting) various oils and compounds from the plant or other raw materials. The liquefied or supercritical CO₂ containing the extracted oils and organic compounds is then transferred to a separator. The separator is maintained at a different temperature and pressure than the extraction vessel which results in the separation of the oil and other extracted compounds from the liquefied or supercritical CO₂ and the conversion of liquefied or supercritical CO₂ into CO₂ gas. The separator is designed to separate heavier compounds from the liquefied or supercritical CO₂. As these heavier compounds are separated from the liquefied or supercritical CO₂, the liquefied or supercritical CO₂ vaporizes and rises to the top portion of the separator. This vaporized CO₂ is entrained with remaining volatile oils and other organic compounds that have yet to be separated from the CO₂. This first type of extraction process is referred to as a gas to liquid/supercritical fluid to gas extraction and may be performed by the dual-purpose gas-liquid extraction pump disclosed herein.

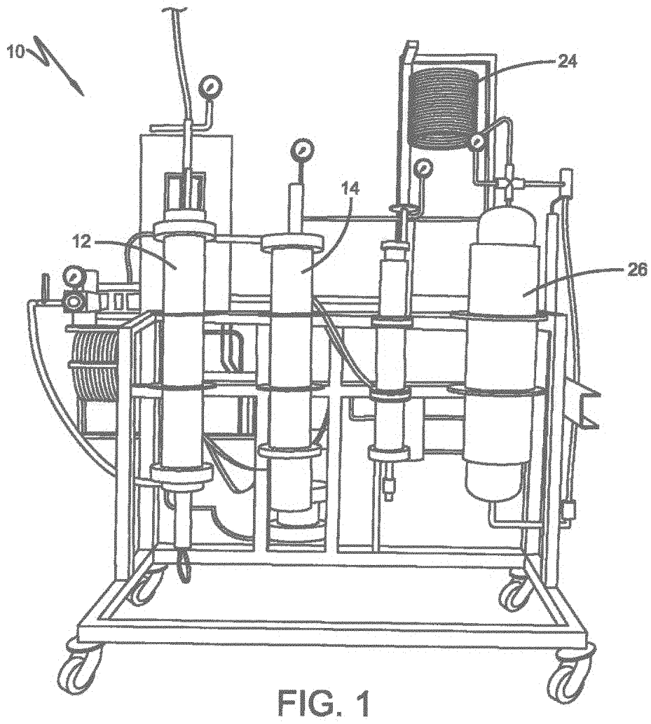

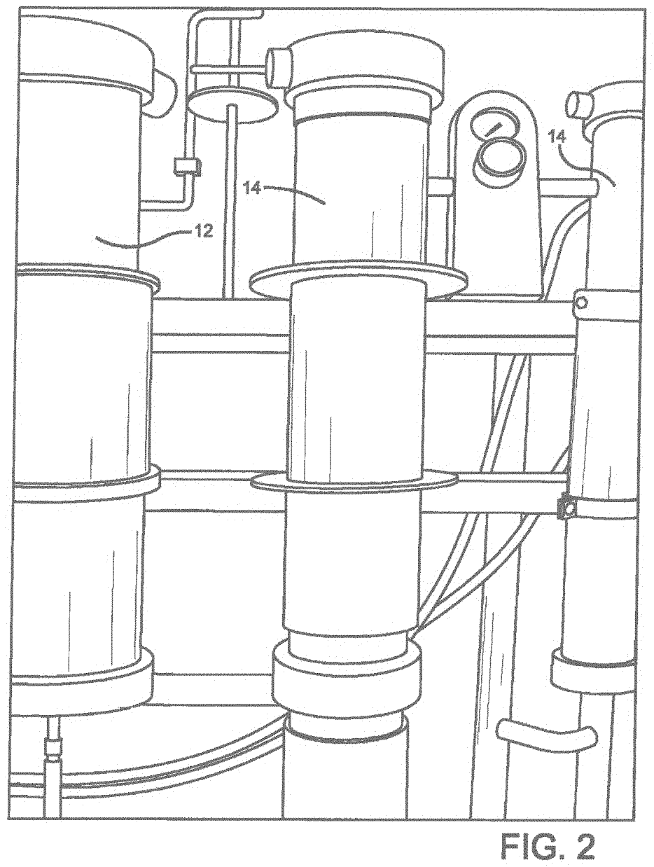

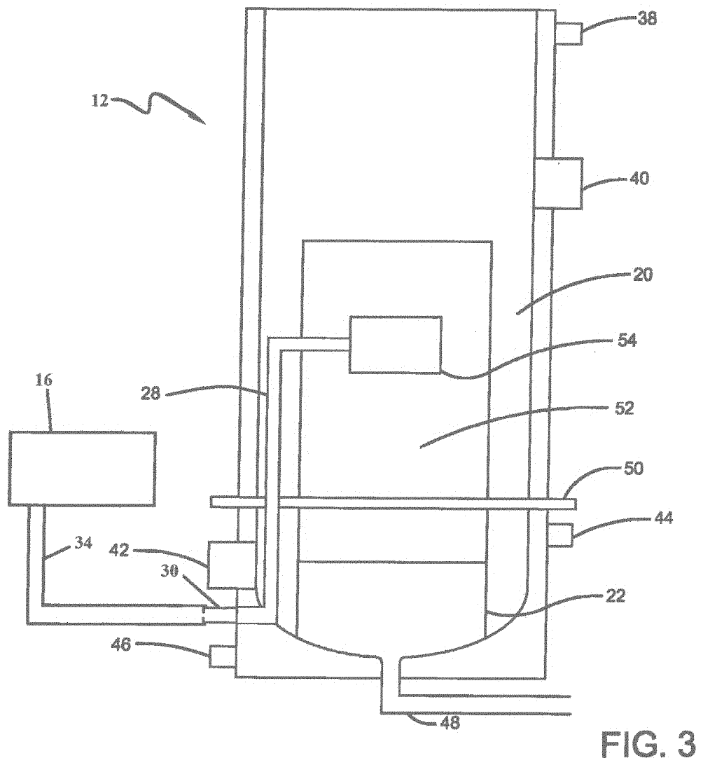

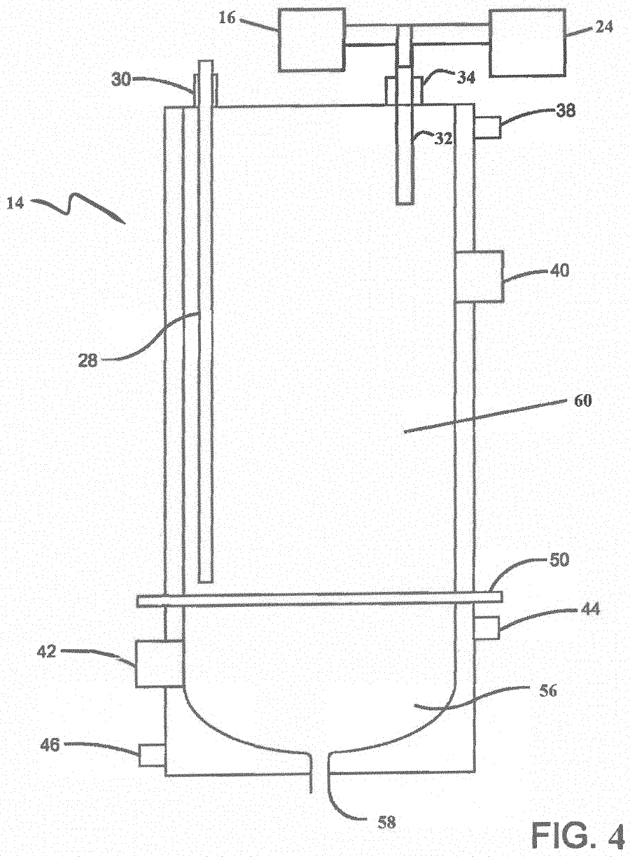

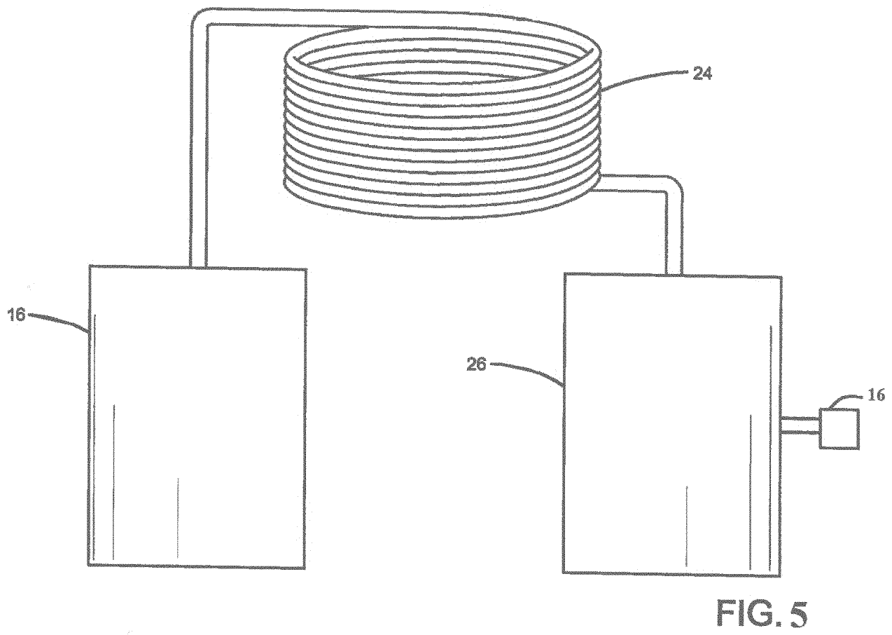

The dual-purpose gas-liquid extraction pump disclosed herein allows for an alternative type of extraction system which allows for gas or liquid phase extractions to be carried out within the same system. Illustrations of various embodiments of the present disclosure are provided within FIGS. 1 through 5. FIG. 1 illustrates an exemplary CO₂ extraction system (10) which includes an extraction vessel (12), a separator (14), an external condenser (24) and an accumulator (26). It is understood, however, that an accumulator is not necessary for operation of the extraction system disclosed herein. FIG. 2 illustrates an insulated extraction vessel (12) and a first and optionally a second separator (14) within a CO₂ extraction system. FIG. 3 illustrates the various component parts of an exemplary extractor vessel (12) which includes an entry port (30) (e.g., a bore through port) for receiving CO₂ in the form of a liquid, supercritical fluid, vapor or gas, an entry tube (28) (e.g., a bore through tube) for passing CO₂ in the form of a liquid, supercritical fluid, vapor or gas to an extraction chamber (52) which houses the organic material to be extracted within a Soxhlet or stainless steel basket (54). FIG. 4 illustrates the various component parts of an exemplary separator vessel (14) which includes an entry port (30) (e.g., a bore through port) for receiving CO₂ in the form of a liquid, supercritical fluid, vapor or gas, an entry tube (28) (e.g., a bore through tube) for passing CO₂ in the form of a liquid, supercritical fluid, vapor or gas to a separation zone (60). The separation zone (60) of the separator is maintained at a different temperature and pressure than the extraction vessel. This results in the separation of the oil and other extracted compounds from the liquefied, supercritical fluid, vapor or gas and the conversion of liquefied or supercritical CO₂ into CO₂ gas or vapor which rises to the top of the separator and exits the separator through an exit tube (32) (e.g., a bore through tube) and exit port (34). Once the CO₂ gas or vapor exits the separator (14), a valve directs the CO₂ gas or vapor to the gas-liquid extraction pump (32) to be recycled within the system for continuous extraction in the gas or vapor phase or to an external condenser for conversion to a liquid or ultimately to a supercritical fluid for later use by the gas-liquid extraction pump for extraction in the liquid phase. FIG. 5 illustrates the various component parts of the condensation system including an external condenser (24) which receives CO₂ gas or vapor from the separator and an accumulator (26) for storing liquid or supercritical CO₂ which transports liquid or supercritical CO₂ to the gas-liquid extraction pump (32) when operating the extraction system in the liquid phase.

The first step of the extraction process involves utilizing a gas-liquid extraction pump (32) to pump CO₂ vapor or gas through conduit (34) to the entry port (30), through the entry tube (28) into the extractor (12) and allowing the extracting material to pass through the organic material within the Soxhlet or stainless-steel basket (54). This step may be referred to as the gas booster mode or gas phase extraction as the pump (32) is switched to gas mode to directly pump CO₂ gas or vapor within the extractor (12). At this time, the extractor (12) is pressurized and maintained at a temperature and pressure which allows the CO₂ to remain in vapor or gas form as it passes through the extractor. The extractor may be pressurized anywhere from about 800 to about 15,000 pounds per square inch (psi) and the temperature of the extractor may be set anywhere from 20° C. to about 50° C. For example, the extractor may be maintained at a pressure anywhere from about 800 to about 1,000 psi or more and may be maintained at a temperature anywhere from between about 20° C. to about 50° C. or at any pressure and temperature which allows for the CO₂ to remain in vapor or gas form. In certain cases, the extractor is pressurized up to about 1000 psi. As the CO₂ passes through the organic material, it acts as a solvent to remove essential oils or light volatile oils including monoterpenes from the organic material. Due to the fact that the extracting material is in gas or vapor form, this step of the extraction process takes a longer period of time to complete than if the extracting material were in liquid form. The extracted mixture then exits the extractor through an exit port (48) and passes through a conduit to an inlet port or bore through port (30) within the separator (14).

The separator (14) is generally set to a pressure which is lower than that of the extractor. In certain embodiments, the separator is set to a pressure between about 350 to about 400 psi. However, in other embodiments, the separator may be maintained at a pressure ranging from about 200 psi to about 400 psi. In general, the separator may be maintained at a higher temperature than the extractor to separate the extractant from the extracting material. The body of the separator vessel is divided into two parts—a main body portion and a bottom body portion. The main body portion of the separator is surrounded by a jacket and is kept relatively warm at a temperature which prevents the depressurized gas or vapor from freezing. The bottom portion of the separator includes a cup which receives and holds the extracted oils. The bottom portion of the separator may thus, be referred to as the collection zone (56). The collection zone (56) may include an exit port (58) and valve for receiving extracted oils from the collection zone (56). As the CO₂ extraction mixture enters the separator, the gas or vapor is depressurized and the extracted constituents (i.e., the essential oils or light volatile oils) are separated or released from the CO₂ extraction mixture and enter the collection zone (22) at the bottom portion of the separator. The bottom portion of the separator is unheated so that depressurized gas containing the extracted material freezes and entrains the light volatile oils or essential oils in dry ice. In certain embodiments, the operator has the option of gently applying heat to the cup at the bottom portion of the separator so that the extracted oils may be squirted out through a valve at the bottom portion of the separator.

Thus, during the first step of the extraction process, the gas-liquid extraction pump pumps CO₂ gas into the extractor to begin the extraction process. The extractor is pressurized and kept at a temperature sufficient maintain the CO₂ in gas or vapor form. By introducing CO₂ into the extractor in the gas phase, the extraction process is slowed down compared to liquid extraction processes. The CO₂ gas or vapor passes through the organic material within the extractor to extract essential oils and light volatile oils from the organic material. The CO₂ gas or vapor then exits the extractor and enters the separator which is maintained at a different temperature and pressure from the extractor which results in the separation of the extracted material from the CO₂. CO₂ gas may then be sent back to the gas-liquid extraction pump for continuous extraction or to the condensation system for conversion into liquid or supercritical form.

After this first phase of the extraction is complete, the second phase of the extraction or second step of the extraction process may begin. The second step of the extraction process, referred to as the liquid phase, involves re-directing CO₂ from the separator to a condenser or liquid condensing system (24) and optionally, an accumulator (26) before liquid or supercritical CO₂ flows back to the gas-liquid extraction pump (16). This may be accomplished by closing flow of CO₂ gas or vapor within a conduit between the separator and the gas-liquid extraction pump and opening flow of CO₂ gas or vapor within a conduit between the separator and the condenser or liquid condensing system (24). This redirection of flow of CO₂ gas or vapor to the condenser or liquid condensing system (24) may be accomplished one or more valves. The condenser or liquid condensing system converts CO₂ gas or vapor into a liquid or into a supercritical fluid. Alternatively, the condenser or liquid condensing system may assist in converting the CO₂ gas or vapor into a supercritical fluid. This is accomplished by the condenser or liquid condensing system receiving warm CO₂ vapor and turning it back to a liquid by cooling it. The liquefied CO₂ or supercritical CO₂ may then pass through a conduit and enter the accumulator (26) for storage and further use and recirculation within the extraction system. The flow of liquid CO₂ or supercritical CO₂ within the conduit connecting the liquid condensing system (24) and the accumulator (26) may be controlled by a valve and/or operation of the gas-liquid extraction pump.

The liquid or supercritical CO₂ may then be delivered to the gas-liquid extraction pump (16) to begin the second step of the extraction process. This may be accomplished by connecting the accumulator (26) to the gas-liquid extraction pump (16) by a conduit and controlling the flow of liquid CO₂ or supercritical CO₂ from the accumulator to the gas-liquid extraction pump (16) by a valve and/or by a vacuum generated by the gas-liquid extraction pump (16) itself. In certain embodiments, the gas-liquid extraction pump is capable of pulling a vacuum ranging between about 23″ to about 27″ Hg to pull liquid CO₂ from the liquid condensing system.

The liquid or supercritical CO₂ stored in the accumulator (26) is relatively cold as it is stored at a temperature of about 5° C. During this step of the process, liquid or supercritical CO₂ flows out of the accumulator (26) to the gas-liquid extraction pump (16) at pressures ranging from about 800 to about 900 psi or at any other pressure and temperature setting within the purview of a person of ordinary skill in the art. When the liquid or supercritical CO₂ enters the gas-liquid extraction pump (16), the gas-liquid extraction pump (16) boosts the pressure of the liquid or supercritical CO₂ up to an extraction pressure ranging from about 800 to about 1000 psi, to an extraction pressure of about 1000 psi or more, to an extraction pressure up to about 1200 psi or more, or to an extraction pressure up to 15,000 psi. The gas-liquid extraction pump delivers the liquid or supercritical CO₂ to the extractor (12) through a conduit and entry tube (28) within the extractor (12). The extractor maintains the pressure generated by the dual-purpose gas-liquid extraction pump to maintain the CO₂ in liquid or supercritical form. In certain embodiments, the liquid or supercritical CO₂ may be heated when it enters the extractor. In certain embodiments, the liquid or supercritical CO₂ may be heated to a temperature from about 20° C. to about 50° C. within the extractor or at any temperature which will allow the extracting material to remain in liquid or supercritical form. In certain embodiments, the extracting material may be heated to a temperature of about 50° C. to form a supercritical fluid. The liquid or supercritical CO₂ may travel up from the bottom of the extractor vessel towards the extraction chamber within the middle portion of the extractor where oils are being dissolved and removed from the plant material. However, it is also contemplated that the extracting material including liquid or supercritical CO₂ may enter the extractor vessel at any point and may also travel from the top of the extractor vessel towards the extraction chamber within the middle portion of the extractor vessel. The oil saturated liquid CO₂ may then flow out of the extractor through an exit port and to the separator (14) through a conduit leading to an inlet port within the separator. Again, the flow of liquid or supercritical CO₂ between the extractor (12) and the separator (14) may be controlled by a valve and/or operation of the gas-liquid extraction pump. The separator (14) operates as a pressure regulator in that it de-pressurizes the liquid or supercritical CO₂ to gas and vapor and causes the extracted oil to fall to the bottom of the separator (14) within the cup. In certain embodiments, the separator is set to a pressure between about 800 psi to about 900 psi. In general, the separator may be maintained at a higher temperature than the extractor to separate the extractant from the extracting material. The vaporized CO₂ may then rise within the separator (14) and exit the separator (14) to either the gas-liquid extraction pump (16) or to the condenser or liquid condensing system (24) to be recycled for further use within the extraction system.

Thus, the extraction pump disclosed herein allows for a dual-purpose gas and liquid extraction to take place within the extraction system. In the gas booster mode or gas phase of the extraction system, gas and vapor exiting out of the separator travels to the inlet of the gas-liquid extraction pump where it is recirculated within the extraction system. In the liquid mode or liquid phase of the extraction system, CO₂ gas/vapor flows to the condenser which cools the gas/vapor to about 5° C. or at any other temperature which allows it to be converted to a liquid or a supercritical fluid (e.g., at any temperature greater than about −56.6° C.). The liquid CO₂ will then optionally flow to the accumulator and ultimately to the gas-liquid extraction pump for extraction in the liquid phase.

Upon completion of the extraction process, a valve and pump system may be used to switch or redirect flow of the CO₂ to one or more storage containers for later use. Once the extractor is fully de-pressurized, the extractor is opened up and the spent solids are disposed of. If a filtration system is present, filters may also be removed and cleaned.

In certain embodiments, the extraction vessel of the present disclosure has a working pressure ranging from about 800 psi to about 15,000 psi. The extraction vessel can be fully opened at each end for cleaning and for placing material for extraction within the extractor. In certain embodiments, the extraction vessel may be jacketed for heating and cooling. Pressurization of the extraction vessel as described in the embodiments set forth herein may be generally achieved through the gas-liquid extraction pump having either an electric or a pneumatic drive.

In certain embodiments, the CO₂ extraction system may also include one or more additional separators which operates in a manner similar to the first separator described above. For example, the CO₂ extraction system may include a second separator which is designed to receive overflow liquid CO₂ from the first separator (i.e., liquid CO₂ which has not had time to convert to CO₂ gas) and/or liquefied CO₂ from the extraction vessel which is transferred or pumped simultaneously from the extraction vessel to both the first separator and the second separator.

The present disclosure also provides for the incorporation of a filtration system within the CO₂ extraction system disclosed herein. An example of a filtration system which may be utilized in the present extraction system is disclosed within U.S. Pat. No. 10,092,855 which is hereby incorporated by reference in its entirety. The filtration system may be incorporated either within the extraction vessel, outside of and between the extraction vessel and the separator vessel, within a separator vessel, between one or more separator vessels and the condensing system, the accumulator or the extraction vessel or outside of and between a first separator and a second separator vessel. The filtration system may provide additional means for separating oil and other extracted compounds from the liquefied CO₂ in addition to the separator to obtain a greater yield of extraction. In further embodiments, the filtration system may be positioned after the condenser which is external to and downstream from the separator so as to accept re-liquefied CO₂. The re-liquefied CO₂ may then enter the accumulator for storage and further use and recirculation within the extraction system.

Thus, the CO₂ extraction system in the embodiment described above includes a high pressure dual-purpose gas-liquid extraction pump, an extraction vessel and at least one separator, a condensing system or condenser and optionally an accumulator. The above disclosure sets forth basic information with respect to the operation of a CO₂ extraction system. Variations of the above-described CO₂ extraction system and corresponding processes include the following embodiments.

Also provided is a method of extracting compounds from an organic material involving the use of any of the extraction systems described herein. The method generally includes the following steps (although it is apparent to a person of ordinary skill in the art that these steps may be modified depending upon the specific components utilized within the extraction system): Pre-Steps: 1) providing a CO₂ extraction system; 2) providing a gas-liquid extraction pump; First Phase Extraction—1) using the gas-liquid extraction pump to pass CO₂ gas or vapor through an organic material within an extraction vessel or a vessel which is partly designed for extraction; 2) separating organic material from the CO₂ gas or vapor by passing the gas or vapor through at least one separator vessel; 3) collecting extracted and separated materials from a separator vessel or a vessel which is partly designed for separation of organic material from the gas or vapor extracting material; 4) storing and recirculating the extracting material through the extraction system; Second Phase Extraction—1) using the gas-liquid extraction pump to pass liquid CO₂ or supercritical CO₂ through an organic material within an extraction vessel or a vessel which is partly designed for extraction; 2) separating organic material from the liquid CO₂ or supercritical CO₂ by passing the liquid or supercritical CO₂ through at least one separator vessel; 3) collecting extracted and separated materials from a separator vessel or a vessel which is partly designed for separation of organic material from the gas or vapor extracting material; 4) storing and recirculating the extracting material through the extraction system.

It is understood to a person of ordinary skill in the art that the CO₂ extraction system described above may include various valves, pumps and other mechanical features as necessary to allow for the passage of fluid (including liquids and gasses) throughout the system. It is further understood to a person of ordinary skill in the art that the CO₂ tank, extraction vessel, first separator, the extractor-separator pressure vessel, accumulator, filtration system and other component parts include various inlets and outlets as necessary to allow fluids to pass between the various vessels and component parts connected within the extraction system. It is also understood that a person of ordinary skill could readily determine the temperatures and pressures which allow for the conversion of CO₂ or any other extracting material between various phases including the gas or vapor phase, the liquid phase, the supercritical fluid phase, and the solid phase and that the extraction system and its various component parts including but not limited to the extractor, separator, dual-purpose gas-liquid extraction pump, condenser or condensing system, accumulator, the various conduits and valves may be designed to accommodate any temperature and pressure setting to change the extracting material from one phase to another or to maintain the extracting material within a particular phase.

### TABLE OF REFERENCE NUMERALS WITHIN THE DRAWINGS

10—Extraction System
12—Extraction Vessel
14—Separator
16—Gas-Liquid Extraction Pump
20—Main Body
22—Collection Zone
24—External Condenser
26—Accumulator
28—Entry Tube (Extractor/Separator)
30—Entry Port (Extractor/Separator)
32—Exit Tube (Separator)
34—Exit Port (Separator)
36—Valve between Gas-Liquid Extraction Pump and Condenser
38—Heating/Cooling Jacket Port
40—View Port
42—View Port
44—Heating/Cooling Jacket Port
46—Heating/Cooling Jacket Port
48—Extractor-Separator Conduit
50—Flange
52—Extraction Chamber
54—Stainless Steel Basket or Soxhlet Basket
56—Collection Zone
58—Collection Tube
60—Separation Zone

While the extraction system has been described above in connection with various illustrative embodiments, it is to be understood that other similar embodiments may be used or modifications and additions may be made to the described embodiments for performing the same function disclosed herein without deviating therefrom. Further, all embodiments disclosed are not necessarily in the alternative, as various embodiments may be combined or subtracted to provide the desired characteristics. Variations can be made by one having ordinary skill in the art without departing from the spirit and scope hereof. Therefore, the extraction system should not be limited to any single embodiment, but rather construed in breadth and scope in accordance with the recitations of the appended claims. The right to claim elements and/or sub-combinations that are disclosed herein as other inventions in other patent documents is hereby unconditionally reserved.

Having thus described the disclosed system and method, it is now claimed:

What is claimed is:

1. An extraction system comprising:
a tank containing gas which comprises an inlet for filling the tank with gas and an outlet for allowing the gas to be transferred within the extraction system;
a multifunctional dual-purpose gas-liquid extraction pump in connection with the tank wherein the pump is capable of pumping either gas or vapor phase extracting material or liquid phase extracting material throughout the extraction system in a gas phase or a liquid phase extraction process;
an extractor pressure vessel in connection with the multifunctional dual-purpose gas-liquid extraction pump, wherein the extractor pressure vessel comprises an entry port, an entry tube, a main body and a collection zone, wherein the main body comprises an extraction chamber, wherein the extraction chamber houses material to be extracted; and
a separator pressure vessel in connection with the extractor pressure vessel, wherein the separator pressure vessel comprises an entry port, an entry tube, a separation zone, a collection zone, an exit tube and an exit port, wherein the exit port is connected to the gas-liquid extraction pump and an external condenser by at least one conduit, wherein flow of material from the exit port to either the gas-liquid extraction pump or the external condenser is controlled by a valve for recirculation within the extraction system.

2. The extraction system of claim 1 further comprising an accumulator in connection with the external condenser, wherein the accumulator stores liquid extracting material, wherein the accumulator is in connection with the gas-liquid extraction pump.

3. The extraction system of claim 2, wherein the gas-liquid extraction pump comprises a switch allowing the gas-liquid extraction pump to alternate between gas mode for pumping CO₂ gas or vapor within the extraction system and liquid mode for pumping liquid CO₂ or supercritical CO₂ within the extraction system.

4. The extraction system of claim 3, wherein the gas-liquid extraction pump pressurizes the gas or vapor phase extracting material and pumps the gas or vapor phase extracting material within an extraction pressure vessel when the extraction system is operating in the gas or vapor phase.

5. The extraction system of claim 4, wherein the gas-liquid extraction pump creates a vacuum which pulls the liquid phase extracting material stored in the accumulator and pumps liquid phase extracting material within the extraction pressure vessel when the extraction system is operating in the liquid phase.

6. The extraction system of claim 5, wherein the gas-liquid extraction pump recirculates the extracting material in the gas or vapor phase by creating a vacuum to pull and receive extracting material exiting the exit tube and exit port of the separator, wherein the valve directs flow of the extracting material to the gas-liquid extraction pump.

7. The extraction system of claim 6, wherein the valve between the gas-liquid extraction pump and the condenser directs flow of the extracting material exiting the exit tube and exit port of the separator to the condenser which converts extracting material in the gas or vapor phase to the liquid phase, wherein the liquid phase extracting material is transported to the accumulator for storage and wherein the gas-liquid extraction pump creates a vacuum to pull and receive liquid phase extracting material from the accumulator for circulation within the extraction system.

8. The extraction system of claim 7, wherein further comprising a valve between the condenser and the accumulator which allows for flow of the liquid phase extracting material to bypass the accumulator and for flow of the liquid phase extracting material to be directed to the gas-liquid extraction pump for recirculation within the extraction system when storage of the liquid phase extracting material within the accumulator is not necessary.

9. The extraction system of claim 5, wherein the gas-liquid extraction pump is explosion proof which enables it to work with different types of flammable compressed gasses.

10. The extraction system of claim 6, wherein the extracting material is CO₂ gas, liquid CO₂ and supercritical CO₂.

11. The extraction system of claim 7, wherein the gas-liquid extraction pump is capable of pumping flammable gases separately or in conjunction with CO₂.

12. The extraction system of claim 11, wherein the extraction system, when operated in the gas or vapor phase extracts essential oils and wherein the extraction system, when operated in the liquid phase, extracts oleo resins and heavy oils.

13. A method of extracting compounds from an organic material comprising the following steps:
providing the extraction system of claim 12;
conducting a first phase extraction, wherein the first phase extraction comprises the following steps:
i.) using the gas-liquid extraction pump to pump CO₂ gas or vapor extracting material into the extraction vessel to pass through organic material within the extraction vessel to entrain the organic material within the extracting material;
ii.) separating organic material from the CO₂ gas or vapor by passing the gas or vapor through at least one separator vessel;
iii.) collecting extracted and separated materials from the separator vessel;
iv.) recirculating the CO₂ gas or vapor extracting material through the extraction system by directing CO₂ gas or vapor from the separator vessel to the gas-liquid extraction pump to recirculate the CO₂ gas or vapor extracting material through the extraction vessel;
conducting a second phase extraction, wherein the second phase extraction comprises the following steps:
i.) using the gas-liquid extraction pump to pump liquid or supercritical CO₂ extracting material into the extraction vessel to pass through organic material within the extraction vessel to entrain the organic material within extracting material;
ii.) separating organic material from the liquid or supercritical CO₂ by passing the liquid or supercritical CO₂ through at least one separator vessel which converts the liquid or supercritical CO₂ to a gas or vapor;
iii.) collecting extracted and separated materials from the separator vessel; and
iv.) recirculating the CO₂ extracting material through the extraction system by directing CO₂ gas or vapor from the separator vessel to the external condenser to convert the CO₂ gas or vapor to the liquid phase and optionally storing the liquid phase CO₂ within the accumulator
v.) operating the gas-liquid extraction pump to create a vacuum to pull the liquid phase CO₂ from the condenser or the accumulator and recirculate liquid phase CO₂ through the extraction vessel.

14. The method of claim 13, further comprising operating a switch on the gas-liquid extraction pump to alternate operation of the extraction system between the gas or vapor phase (the first phase extraction) and the liquid phase (the second phase extraction).

15. The method of claim 14, further comprising operating the valve between the gas-liquid extraction pump and the condenser to direct flow of the extracting material in the gas or vapor phase exiting the exit tube and exit port of the separator to the either the gas-liquid extraction pump for continuous extraction in the gas or vapor phase (first phase extraction) or to the condenser for continuous extraction in the liquid phase (second phase extraction).

16. A method for extracting compounds from an organic material comprising the following steps:
conducting a first phase extraction, wherein the first phase extraction comprises the following steps:
i.) using a gas-liquid extraction pump to pump CO₂ gas or vapor extracting material into a extraction vessel to pass through organic material within the extraction vessel to entrain the organic material within the extracting material;
ii.) separating organic material from the CO₂ gas or vapor by passing the gas or vapor through at least one separator vessel;
iii.) collecting extracted and separated materials from the separator vessel;
iv.) recirculating the CO₂ gas or vapor extracting material through the extraction system by directing CO₂ gas or vapor from the separator vessel to the gas-liquid extraction pump to recirculate the CO₂ gas or vapor extracting material through the extraction vessel;
conducting a second phase extraction, wherein the second phase extraction comprises the following steps:
vi.) using the gas-liquid extraction pump to pump liquid or supercritical CO₂ extracting material into the extraction vessel to pass through organic material within the extraction vessel to entrain the organic material within extracting material;
vii.) separating organic material from the liquid or supercritical CO₂ by passing the liquid or supercritical CO₂ through at least one separator vessel which converts the liquid or supercritical CO₂ to a gas or vapor;
viii.) collecting extracted and separated materials from the separator vessel; and
ix.) recirculating the CO₂ extracting material through the extraction system by directing CO₂ gas or vapor from the separator vessel to an external condenser to convert the CO₂ gas or vapor to the liquid phase and optionally storing the liquid phase CO₂ within an accumulator;
x.) operating the gas-liquid extraction pump to create a vacuum to pull the liquid phase CO₂ from the condenser or the accumulator and recirculate liquid phase CO₂ through the extraction vessel.
